(19) United States
(12) Patent Application Publication
(10) Pub. No.: US 2025/0178393 A1
(43) Pub. Date: Jun. 5, 2025

(54) DOUBLE SHEAR RADIUS ROD MOUNTING SYSTEM

(71) Applicant: Shock Therapy Suspension, Inc., Duluth, GA (US)

(72) Inventor: Justin Smith, Wittmann, AZ (US)

(21) Appl. No.: 18/529,466

(22) Filed: Dec. 5, 2023

(51) Int. Cl. B60G 7/00; B60G 3/00

(52) U.S. Cl. CPC B60G 7/008; B60G 3/00; F16C 11/0614; B60G 2204/148

(57) ABSTRACT

A double shear radius rod mounting system is provided. The system includes a double shear bracket, a coupling system, and a vehicle member adjacent a wheel of a vehicle. The double shear bracket is coupled to the vehicle member. The coupling system couples a rod end of a radius rod between the vehicle member and the double shear bracket to supply shear force resistance on two sides of the rod ends. The double shear bracket comprises a base plate, a shear plate, and connector plates coupled between the base plate and the shear plate to retain the shear plate parallel with the base plate. The vehicle member is a shear plate on one side of the rod end and the shear plate of the double shear bracket on an opposing side of the rod end.

### BACKGROUND OF THE INVENTION

### Technical Field

This invention relates generally to radius rod mounting system, and more particularly to a double shear radius rod mounting system.

### State of the Art

Radius rods are a fundamental component of a UTV. The radius rods keep the rear wheels aligned as the suspension compresses and depresses. If one of the rods is bent, it could cause many different issues that can hinder the performance of the UTV. Conventional radius rods are coupled to the vehicle member adjacent a wheel with a bolt or other connector on a single side of the radius rod. The vehicle member then acts as a shear plate on only a single side of radius rod. This single shear configuration exposes the radius rod to additional forces that can result in shear forces that damage the rod end or the bolt coupling the rod end to the vehicle member.

Accordingly, there is a need for a double shear radius rod mounting system that provides a shear plate on each side of the bolt coupling a rod end of a radius rod to a vehicle member.

### SUMMARY OF THE INVENTION

An embodiment includes a double shear radius rod mounting system comprising: a double shear bracket; a coupling system; and a vehicle member adjacent a wheel of a vehicle, wherein: the double shear bracket is coupled to the vehicle member; and the coupling system couples a rod end of a radius rod between the vehicle member and the double shear bracket to supply shear force resistance on two sides of the rod ends.

Another embodiment includes a method of using a double shear radius rod mounting system, the method comprising: coupling a double shear bracket to a vehicle member adjacent a wheel of a vehicle; coupling a rod end of a radius rod between the vehicle member and a shear plate of the double shear bracket; and providing resistance to shear forces in response to the coupling to the vehicle member and the shear plate of the double shear bracket.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a double shear bracket with a rod end of a coupled thereto, according to an embodiment;

FIG. 2 is an exploded perspective view of a double shear bracket with a rod end coupled thereto, according to an embodiment;

FIG. 3 is a perspective view of a double shear bracket, according to an embodiment;

FIG. 4 is a perspective view of a pin for coupling a rod end of a radius rod to a vehicle member, according to an embodiment;

FIG. 5 is a perspective view of a spacer for coupling a rod end of a radius rod to a double shear bracket, according to an embodiment;

FIG. 6 is a perspective view of a double shear radius rod mounting system, according to an embodiment; and

FIG. 7 is a flow chart depicting a method of using a double shear radius rod mounting system, according to an embodiment.

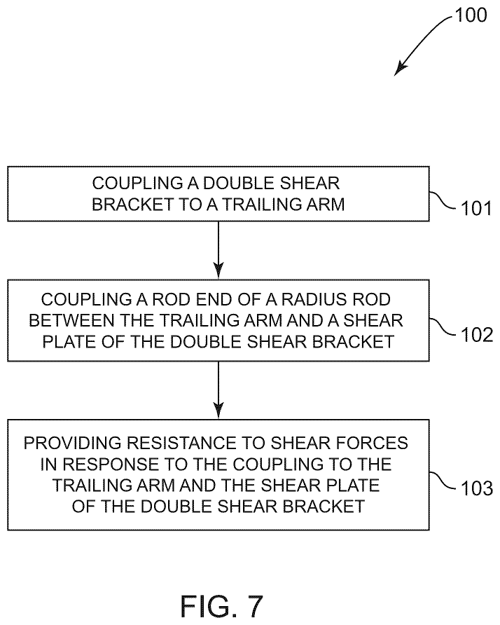

### DETAILED DESCRIPTION OF EMBODIMENTS OF THE INVENTION

As discussed above, embodiments of the present invention relate to a double shear radius rod mounting system that provides a shear plate on each side of a rod end of a radius rod coupled to a vehicle member.

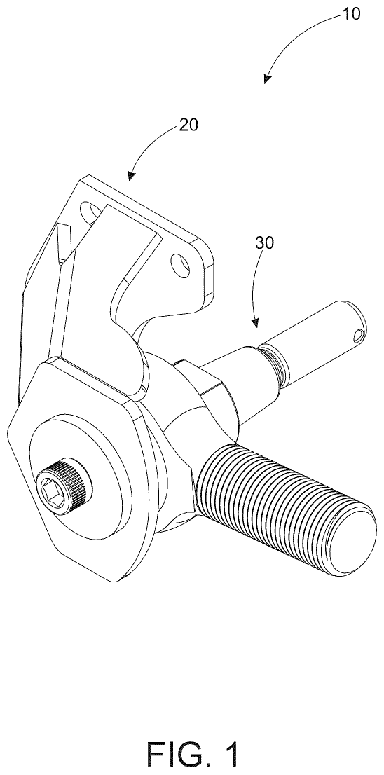

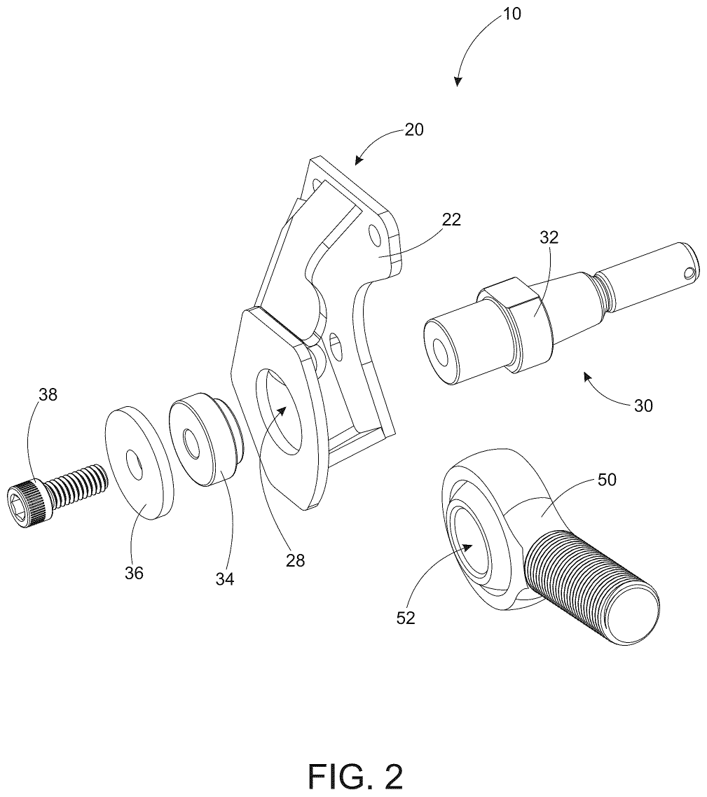

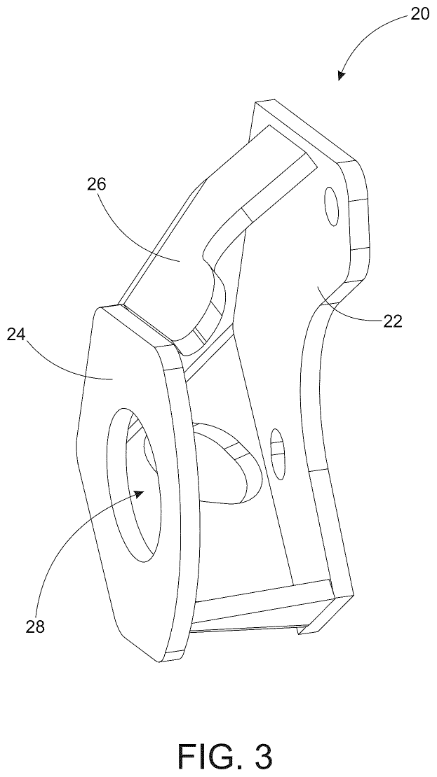

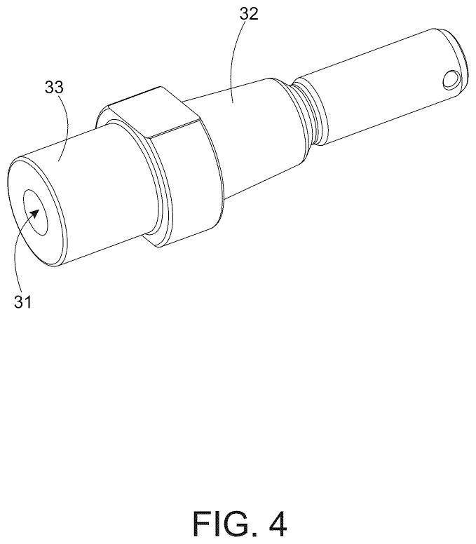

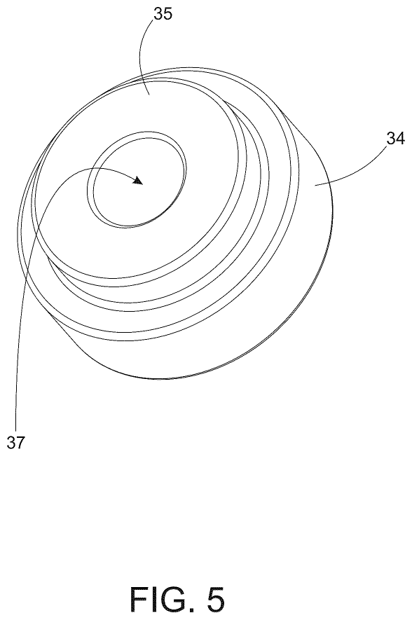

Referring to FIGS. 1-6, an embodiment of a double shear radius rod mounting system 10 is depicted. The system 10 comprises a double shear bracket 20, a coupling system 30, and a vehicle member 40. The double shear bracket 20 comprises a base plate 22, a shear plate 24, connector plates 26 coupled between the base plate 22 and the shear plate 26 to retain the shear plate 24 parallel with the base plate 22. The shear plate includes an aperture 28 for receiving a spacer 34 of the coupling system 30. The coupling system comprises a pin 32, a spacer 34, a washer 36 and a bolt 38.

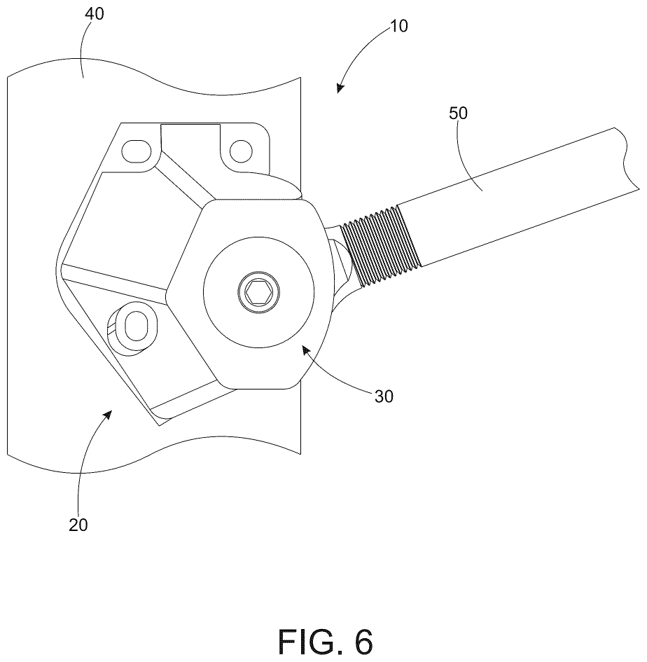

In operation, the base plate 22 of the double shear bracket 20 is coupled to the vehicle member 40 located adjacent a wheel of a vehicle. The vehicle member 40 may be a hub, a spindle, an upright, a trailing arm or the like. The pin 32 of the coupling system 30 is coupled to the vehicle member 40. The rod end 50 may be coupled to the pin 32 in response to rod pin portion 33 of the pin 32 extending into an aperture 52 of the rod end 50. The spacer 34 may be inserted through the aperture 28 of the shear plate 24 with a reduced diameter portion 35 of the spacer 34 extending into the aperture 52 of the rod end 50. The washer 36 is coupled to the shear plate 24 with the bolt 38 that extends through an aperture 37 of the spacer 34 and couple to the recess 31 in the pin 32. In this configuration, the vehicle member 40 is a shear plate on one side of the rod end 50 and the shear plate 24 of the double shear bracket 20 on an opposing side of the rod end 50, as shown in FIG. 6. In at least this way, the double shear radius rod mounting system 10 operates to provide a shear plate on two sides of the rod end 50 of a radius rod.

Additionally, the double shear bracket 20 includes the connector plate 26 that forms a pocket bounded by the base plate 22, the shear plate 24 and the connector plates 26. The rod end 50 when coupled within the double shear radius rod mounting system 10 is also protected by damage from external debris and so forth.

An embodiment includes a method 100 of using a double shear radius rod mounting system 10. The method 100 comprises coupling a double shear bracket to a vehicle member (Step 101); coupling a rod end of a radius rod between the vehicle member and a shear plate of the double shear bracket (Step 102); and providing resistance to shear forces in response to the coupling to the vehicle member and the shear plate of the double shear bracket (Step 103).

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A double shear radius rod mounting system comprising:
a double shear bracket;
a coupling system; and
a vehicle member adjacent a wheel of a vehicle, wherein:
the double shear bracket is coupled to the vehicle member; and
the coupling system couples a rod end of a radius rod between the vehicle member and the double shear bracket to supply shear force resistance on two sides of the rod ends.

2. The system of claim 1, wherein the double shear bracket comprises a base plate, a shear plate, and connector plates coupled between the base plate and the shear plate to retain the shear plate parallel with the base plate.

3. The system of claim 2, wherein the coupling system comprises a pin, a spacer, a washer and a bolt.

4. The system of claim 1, wherein the vehicle member comprises a hub, a spindle, an upright, or a trailing arm.

5. A method of using a double shear radius rod mounting system, the method comprising:
coupling a double shear bracket to a vehicle member adjacent a wheel of a vehicle;
coupling a rod end of a radius rod between the vehicle member and a shear plate of the double shear bracket; and
providing resistance to shear forces in response to the coupling to the vehicle member and the shear plate of the double shear bracket.

6. The method of claim 5, wherein the vehicle member comprises a hub, a spindle, an upright, or a trailing arm.

7. The method of claim 5, wherein the double shear bracket comprises a base plate, the shear plate, and connector plates coupled between the base plate and the shear plate to retain the shear plate parallel with the base plate.

8. The method of claim 7, wherein coupling the rod end of the radius rod between the vehicle member and the shear plate of the double shear bracket comprises using a coupling system.

9. The method of claim 8, wherein the coupling system comprises a pin, a spacer, a washer and a bolt.

10. The method of claim 9, wherein using the coupling system comprises:
coupling the pin to the vehicle member;
coupling the rod end to the pin in response to the pin extending into an aperture of the rod end;
coupling the spacer through the aperture of the shear plate with a reduced diameter portion of the spacer extending into the aperture of the rod end; and
coupling the washer to the shear plate with the bolt that extends through an aperture of the spacer and coupling to a recess in the pin.
